(19) United States
(12) Patent Application Publication
(10) Pub. No.: US 2008/0272979 A1
(43) Pub. Date: Nov. 6, 2008

(54) Antenna Arrangement

(75) Inventors: Alain Kupek, Wittenheim (FR); Ronnie Weissenfeld, Efringen-Kirchen (DE); Gunter Tremmel, Schworstadt (DE)

Correspondence Address: BAKER & DANIELS LLP;111 E. WAYNE STREET, SUITE 800, FORT WAYNE, IN, 46802, US

(73) Assignee: A.RAYMOND ET CIE, Grenoble (FR)

(21) Appl. No.: 12/090,285

(22) PCT Filed: Oct. 11, 2006
(86) PCT No.: PCT/EP2006/009794

§ 371 Date: Apr. 15, 2008

(30) Foreign Application Priority Data
Oct. 26, 2005 (DE) DE102005051190.2

(51) Int. Cl. H01Q 1/12

(52) U.S. Cl. 343/888

(57) ABSTRACT

An antenna arrangement has a base body (9), a bearing arrangement which interacts with the base body (9) and has a bearing piece (17), and the antenna arrangement also has an antenna rod (1) which is connected in a captive manner to the bearing arrangement once a latching connection is produced between latching means (29) and a latching head (25) which is formed at one end of a central pin (22), and which can be pivoted with respect to the base body (9). The bearing piece (17) has an external thread (19), and is formed with a receptacle area (20) in which the central pin (22) can be moved in the longitudinal direction. The antenna rod (1) is connected to an attachment piece (28), on which the latching means (29) are formed and which is provided with an internal thread (27), which engages with the external thread (19) that is formed on the bearing piece (17). This results in relatively simple assembly.

### RELATED APPLICATION

This application is a U.S. National Phase Patent Application based on International Application Serial No. PCT/US2006/009794 filed Oct. 11, 2006, the disclosure of which is hereby explicitly incorporated by reference herein.

### BACKGROUND OF THE INVENTION

1. Field of the Invention

The invention relates to an antenna arrangement.

2. Description of the Related Art

One type of antenna arrangement is known from EP 0 891 001 A1. The known antenna arrangement has a base plate and a bearing arrangement which interacts with the base plate and has a bearing piece. Furthermore, there is an antenna rod which is connected in a theft-proof manner to the bearing arrangement once a latching connection is produced between latching means and a latching head which is formed at one end of a central pin. The connection between the base plate and the antenna rod is made by means of a screw connection which is to a certain degree separable, the antenna rod being able to be pivoted with respect to the base plate in a separated arrangement of the screw connection. The mechanical effort required for this is not, however, insignificant and leads to a relatively high level of effort in assembly. Particularly during assembly of the known antenna arrangement, complex sequences of movements must be executed at right angles to one another.

### SUMMARY OF THE INVENTION

The present invention provides an antenna arrangement which is characterized by a relatively simple mechanical design, which brings about a relatively efficient assembly.

The embodiment of the antenna arrangement according to the invention requires only linear movements in one direction in order to bring it into an installation-ready condition.

In one form thereof, the present invention provides an antenna arrangement with a base body, with a bearing arrangement which interacts with the base body and has a bearing piece, and with an antenna rod which is connected in a captive manner to the bearing arrangement once a latching connection is produced between latching means and a latching head which is formed at one end of a central pin, and which can be pivoted with respect to the base body, characterized in that the bearing piece has an outside thread and is formed with a receptacle area, in which the central pin is movable in the longitudinal direction, and that the antenna rod is connected with a fastening piece, on which the latching means are formed and which is provided with an inside thread that is engaged with an outside thread formed on the bearing piece.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of an antenna arrangement according to the invention in which the antenna rod is arranged at an angle with respect to a foot part; and

FIG. 2 is a cross section of the exemplary embodiment according to FIG. 1 in the area of the foot part, the antenna rod being arranged in an arrangement aligned with the foot part.

Corresponding reference characters indicate corresponding parts throughout the several views. Although the exemplifications set out herein illustrate an embodiment of the invention, the embodiment disclosed below is not intended to be exhaustive or to be construed as limiting the scope of the invention to the precise form disclosed.

### DETAILED DESCRIPTION

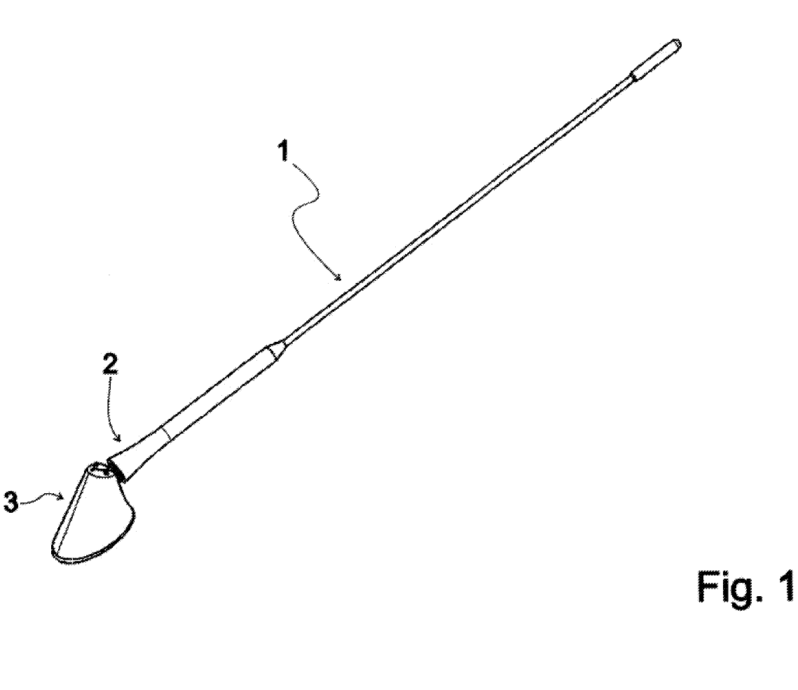

FIG. 1 shows, in a perspective view, an exemplary embodiment of an antenna arrangement according to the invention, which has an elongated antenna rod 1. The antenna rod 1 is connected in a pivoting manner with a foot part 3 at a connection end 2. The foot part 3 is designed to be attached, for example, to the exterior of an automobile body, preferably on the roof.

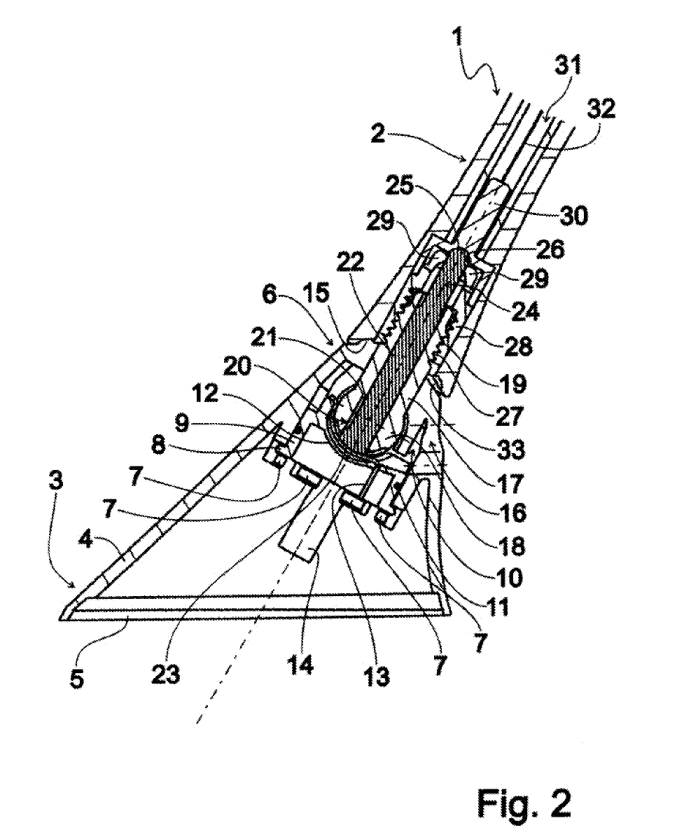

FIG. 2 shows, in a cross section of the exemplary embodiment shown in FIG. 1, the antenna rod 1, being shown in FIG. 2 in an operating arrangement in which it is essentially aligned in a straight line with the longitudinal axis of the foot part 3. It can be seen from FIG. 2 that the foot part 3 has an internally hollow terminating body 4, which extends from a base side 5 at a slanted angle and tapering in the direction of a head side 6. An arrangement of interior latching hooks 7 is present in the region of the head side 6, which engage around the circumference with a notch 8 in a base body 9 and connect it firmly with the terminating body 4.

The base body 9 extends with a sleeve section from the latching hooks 7 pointing the way into a receptacle channel 10 of the terminating body 4, a ring gasket 11 being arranged between the sleeve section of the base body 9 and the receptacle channel 10. On the end of the sleeve section that protrudes into the receptacle channel 10, the base body 9 has a dome-like bearing recess 12 in which an appropriately shaped contact section of a metallic contact strip 13 is inserted. The contact strip 13 is supported with a free end on the base body 9 and extends with another end onto the side of the base body 9 that is turned towards the base side 5 of the foot part 3, where it is joined with a likewise electrically conducting connector piece 14.

Finally, the foot part 3 is formed on its head side 6 with a number of outward-protruding fixing projections 15 as well as with a clearance 16 to accept a part of the connecting end 2 in pivoted arrangement of the antenna rod 1.

Furthermore, the described exemplary embodiment of the antenna arrangement has an elongated, essentially cylindrical bearing piece 17, which is formed with a spherically thickened bearing head 18 on one end and with an outside thread 19 on the other end. The bearing piece 17 is formed with a continuous receptacle area 20 of the bearing piece 17, extending in the longitudinal direction, which is enlarged with respect to the rest of the cross section in the region of the bearing head 18 and is formed with a stop step 21 in the transition area from the larger cross section to the smaller cross section.

It can be seen from FIG. 2 that a likewise elongated, essentially cylindrically shaped central pin 22 is arranged in the receptacle area 20 of the bearing piece 17. The central pin 22 has, on its end, arranged in the region of the bearing head 18 of the bearing piece 17, a stop bead 23 protruding radially outward, and on the opposite end, an end section 24 with a reduced diameter, which is closed off by a latching head 25 whose diameter is greater than that of the end section 24 and corresponds to that of the middle part of the central pin 22. This ensures a simple pass-through. Between the end section 24 and the latching head 25, an engaging step 26 is formed, which is essentially arranged perpendicular to the longitudinal axis of the central pin 22.

It can also be seen from FIG. 2 that the outside thread 19 of the bearing piece 17 is engaged with an inside thread 27 of a threaded sleeve 28, which is connected with the connecting end 2 of the rod 1 in a rotationally fixed manner. The threaded sleeve 28 has, on the end pointing away from the foot part 3, a number of head prongs 29 as latching means, which lie adjacent to the end section 24 of the central pin 22 and engage with the engaging step 26, after the central pin 22 has been pushed through from the side of the bearing head 18 into the receptacle area 20 in the intended arrangement according to FIG. 2.

Finally, it can be seen from FIG. 2 that a fixing element 30, connected with the antenna rod 1, connects to the threaded sleeve 28, through which an antenna cable 32 is passed, arranged in a wire receptacle area 31 of the antenna rod 1 and electrically contacted with the central pin 22.

To tilt the antenna rod 1 from the arrangement according to FIG. 2 into the arrangement according to FIG. 1, the antenna rod 1 is rotated until the fixing projections 15 exit from a fixing groove 33 that is formed on the connecting end 2 and faces the foot part 3, and the connecting end 2 can be pivoted into the clearance 16. The process of separating the screw connection between the bearing piece 17 and the threaded sleeve 28 is limited by the stop of the stop bead 23 on the stop step 21, the antenna rod 1 remaining connected in a captive manner and thus a theft-proof manner with the foot part 3 through the engagement of the engaging step 26 through the head prong 29.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The invention relates to an antenna arrangement as described in the preamble of claim 1.

Such an antenna arrangement is known from EP 0 891 001 A1. The known antenna arrangement has a base plate and a bearing arrangement which interacts with the base plate and has a bearing piece. Furthermore, there is an antenna rod which is connected in a theft-proof manner to the bearing arrangement once a latching connection is produced between latching means and a latching head which is formed at one end of a central pin. The connection between the base plate and the antenna rod is made by means of a screw connection which is to a certain degree separable, the antenna rod being able to be pivoted with respect to the base plate in a separated arrangement of the screw connection. The mechanical effort required for this is not, however, insignificant and leads to a relatively high level of effort in assembly. Particularly during assembly of the known antenna arrangement, complex sequences of movements must be executed at right angles to one another.

The object of the invention is to provide an antenna arrangement of the kind cited in the beginning, which is characterized by a relatively simple mechanical design, which brings about a relatively efficient assembly.

This object is achieved in an antenna arrangement according to the invention of the type mentioned at the outset with the characteristic features of claim 1.

The embodiment of the antenna arrangement according to the invention requires only linear movements in one direction in order to bring it into an installation-ready condition.

Further useful embodiments of the invention are the subject of the subclaims.

The following description of a preferred exemplary embodiment, with reference to the figures of the drawing, gives rise to further useful embodiments and advantages. Shown are:

FIG. 1 A perspective view of an exemplary embodiment of an antenna arrangement according to the invention in which the antenna rod is arranged at an angle with respect to a foot part, and

FIG. 2 A cross section of the exemplary embodiment according to FIG. 1 in the area of the foot part, the antenna rod being arranged in an arrangement aligned with the foot part.

FIG. 1 shows, in a perspective view, an exemplary embodiment of an antenna arrangement according to the invention, which has an elongated antenna rod 1. The antenna rod 1 is connected in a pivoting manner with a foot part 3 at a connection end 2. The foot part 3 is designed to be attached, for example, to the exterior of an automobile body, preferably on the roof.

FIG. 2 shows, in a cross section of the exemplary embodiment shown in FIG. 1, the antenna rod 1, being shown in FIG. 2 in an operating arrangement in which it is essentially aligned in a straight line with the longitudinal axis of the foot part 3. It can be seen from FIG. 2 that the foot part 3 has an internally hollow terminating body 4, which extends from a base side 5 at a slanted angle and tapering in the direction of a head side 6. An arrangement of interior latching hooks 7 is present in the region of the head side 6, which engage around the circumference with a notch 8 in a base body 9 and connect it firmly with the terminating body 4.

The base body 9 extends with a sleeve section from the latching hooks 7 pointing the way into a receptacle channel 10 of the terminating body 4, a ring gasket 11 being arranged between the sleeve section of the base body 9 and the receptacle channel 10. On the end of the sleeve section that protrudes into the receptacle channel 10, the base body 9 has a dome-like bearing recess 12 in which an appropriately shaped contact section of a metallic contact strip 13 is inserted. The contact strip 13 is supported with a free end on the base body 9 and extends with another end onto the side of the base body 9 that is turned towards the base side 5 of the foot part 3, where it is joined with a likewise electrically conducting connector piece 14.

Finally, the foot part 3 is formed on its head side 6 with a number of outward-protruding fixing projections 15 as well as with a clearance 16 to accept a part of the connecting end 2 in pivoted arrangement of the antenna rod 1.

Furthermore, the described exemplary embodiment of the antenna arrangement has an elongated, essentially cylindrical bearing piece 17, which is formed with a spherically thickened bearing head 18 on one end and with an outside thread 19 on the other end. The bearing piece 17 is formed with a continuous receptacle area 20 of the bearing piece 17, extending in the longitudinal direction, which is enlarged with respect to the rest of the cross section in the region of the bearing head 18 and is formed with a stop step 21 in the transition area from the larger cross section to the smaller cross section.

It can be seen from FIG. 2 that a likewise elongated, essentially cylindrically shaped central pin 22 is arranged in the receptacle area 20 of the bearing piece 17. The central pin 22 has, on its end, arranged in the region of the bearing head 18 of the bearing piece 17, a stop bead 23 protruding radially outward, and on the opposite end, an end section 24 with a reduced diameter, which is closed off by a latching head 25 whose diameter is greater than that of the end section 24 and corresponds to that of the middle part of the central pin 22. This ensures a simple pass-through. Between the end section 24 and the latching head 25, an engaging step 26 is formed, which is essentially arranged perpendicular to the longitudinal axis of the central pin 22.

It can also be seen from FIG. 2 that the outside thread 19 of the bearing piece 17 is engaged with an inside thread 27 of a threaded sleeve 28, which is connected with the connecting end 2 of the rod 1 in a rotationally fixed manner. The threaded sleeve 28 has, on the end pointing away from the foot part 3, a number of head prongs 29 as latching means, which lie adjacent to the end section 24 of the central pin 22 and engage with the engaging step 26, after the central pin 22 has been pushed through from the side of the bearing head 18 into the receptacle area 20 in the intended arrangement according to FIG. 2.

Finally, it can be seen from FIG. 2 that a fixing element 30, connected with the antenna rod 1, connects to the threaded sleeve 28, through which an antenna cable 32 is passed, arranged in a wire receptacle area 31 of the antenna rod 1 and electrically contacted with the central pin 22.

To tilt the antenna rod 1 from the arrangement according to FIG. 2 into the arrangement according to FIG. 1, the antenna rod 1 is rotated until the fixing projections 15 exit from a fixing groove 33 that is formed on the connecting end 2 and faces the foot part 3, and the connecting end 2 can be pivoted into the clearance 16. The process of separating the screw connection between the bearing piece 17 and the threaded sleeve 28 is limited by the stop of the stop bead 23 on the stop step 21, the antenna rod 1 remaining connected in a captive manner and thus a theft-proof manner with the foot part 3 through the engagement of the engaging step 26 through the head prong 29.

1-5. (canceled)

6. An antenna arrangement, comprising:
a base body;
a bearing arrangement interacting with said base body, said bearing arrangement including a bearing piece having an external thread and a receptacle area, and a central pin movable in a longitudinal direction within said bearing piece and having a latching head at one end thereof; and
an antenna rod connected to a fastening piece, said fastening piece having an internal thread engaging said external thread of said bearing piece, said antenna rod pivotable with respect to said base body, and said fastening piece further having a latching means latchable with said latching head to capture said antenna rod in a captive manner with respect to said base body.

7. The antenna arrangement of claim 6, further comprising a foot part having a plurality of latching prongs, said latching prongs engaging about a circumference of said base body.

8. The antenna arrangement of claim 6, wherein said base body includes a dome-shaped bearing recess, and said bearing piece has a spherically shaped, thickened bearing head disposed within said bearing recess.

9. The antenna arrangement of claim 8, wherein said central pin is made of metal and is electrically connected with an antenna cable disposed within said antenna rod, said central pin protruding outwardly of said bearing head and electrically connected to an electrically conducting contact strip disposed between said bearing recess and said bearing head.

10. The antenna arrangement of claim 6, wherein said central pin includes an end section with a reduced cross section and a bearing head on said end section, said bearing head having an enlarged cross section with respect to said end section, said latching means disposed adjacent to said end section and engagable with an engaging step formed between said end section and said bearing head.
